(19) United States
(12) Patent Application Publication
(10) Pub. No.: US 2006/0159238 A1
(43) Pub. Date: Jul. 20, 2006

(54) Voice talk system, voice talk control apparatus, voice talk control method, and voice talk control program

(76) Inventors: Takashi Akita, Osaka (JP); Tsuyoshi Kindo, Osaka (JP); Noboru Katta, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/317,195

(22) Filed: Dec. 27, 2005

(30) Foreign Application Priority Data
Dec. 28, 2004 (JP) 2004-380781
Jan. 24, 2005 (JP) 2005-015619

(51) Int. Cl. H04M 1/64

(52) U.S. Cl. 379/67.1; 379/88.01

(57) ABSTRACT

A voice talk system 1 comprises a voice talk apparatus 11, and a voice talk control apparatus 13 which controls a talk between a sender's user and a receiver's user. In the voice talk control apparatus 13, after voice and additional information are received via a network 14, a database is searched using the received voice and additional information as search keys to specify a receiver's user. A grouping section groups the specified receiver's user(s) together. Further, a priority setting section is provided which assigns ordinal numbers as priorities for establishing a connection, to the receiver's users grouped by the grouping section.

### BACKGROUND OF THE INVENTION

1. Field of the Invention

The present invention relates to a voice talk system, a voice talk control apparatus, a voice talk control method, and a voice talk control program, and more particularly, to a technique of controlling a talk between a sender's voice talk apparatus and a receiver's voice talk apparatus.

2. Description of the Background Art

Recently, a Push-To-Talk (hereinafter abbreviated as “PTT”) function, which is started only by pushing a conversation button and allows a communication with one or more persons, has been started being carried in voice talk apparatuses, such as a mobile telephone and the like. For example, Japanese Patent Laid-Open Publication No. 2003-271193 discloses that, with such a PTT function, a voice uttered by a certain user is delivered via a digital network to voice talk apparatuses carried with all persons which are previously grouped together. In PTT, a talk started as described above is communicated by half-duplex communication.

However, in the case of the above-described voice talk apparatus, persons on the other end need to be previously grouped together and registered. Therefore, the user of the voice talk apparatus needs to perform a burdensome registration operation.

Also in PTT, when one user utters a voice, a number of other persons often respond almost simultaneously. In this case, it is difficult for the user to recognize who the user is talking with.

### SUMMARY OF THE INVENTION

Therefore, an object of the present invention is to provide a voice talk system, a voice talk control apparatus, a voice talk control method, and a voice talk control program, a registration operation of which the user is not likely to feel that is burdensome, and a voice talk system and a voice talk control apparatus in which a sender's user readily identifies a party on the other end of a communication.

The present invention has the following features to attain the object mentioned above. A first aspect of the present invention is directed to a voice talk system in which a plurality of voice talk apparatuses and a voice talk control apparatus are connected to each other via a network so that the plurality of voice talk apparatuses and the voice talk control apparatus communicate with each other. The plurality of voice talk apparatuses include a sender's voice talk apparatus capable of transmitting a group talk and one or more receiver's voice talk apparatuses capable of receiving a group talk, and the voice talk control apparatus controls a group talk established between the sender's voice talk apparatus and the at least one of the receiver's voice talk apparatuses.

The sender's voice talk apparatus comprises a talk starting section operable to start a group talk, a microphone operable to receive a voice input while the talk starting section is being operated, an additional information obtaining section operable to obtain additional information required to group the receiver's voice talk apparatuses, and a talk apparatus's transmission section operable to transmit the voice received through the microphone and the additional information obtained by the additional information obtaining section to the network.

The voice talk control apparatus comprises a control apparatus's reception section operable to receive the voice and the additional information transmitted via the network from the sender's voice talk apparatus, a search section operable to search a database configured to search the receiver's voice talk apparatuses, using at least one of the voice and the additional information received by the control apparatus's reception section, to specify at least one of the receiver's voice talk apparatuses with which the sender's voice talk apparatus can currently have a group talk, and a grouping section operable to group the at least one of the receiver's voice talk apparatuses specified by the search section, and hold at least the receiver's voice talk apparatuses registered in the group until a group talk between the sender's voice talk apparatus and the receiver's voice talk apparatuses is ended.

When the sender's voice talk apparatus has a push-to-talk function, the talk starting section is a button operable on the sender's voice talk apparatus.

When the sender's voice talk apparatus can be carried in a vehicle, the additional information contains at least location information with which a current location of the sender's voice talk apparatus can be specified and identification information which is related to a user of the sender's voice talk apparatus, the location information contains at least one of the current location, a location of a destination, a movement speed, a traveling direction, and a route to the destination of the sender's voice talk apparatus, and the identification information contains at least one of a name, an age, an address, a telephone number, a mail address, a nickname, and preference information of a user of the sender's voice talk apparatus, and the search section searches for the receiver's voice talk apparatus located in a vicinity of the current location, the destination, and/or the route to the destination of the sender's voice talk apparatus, with reference to the additional information.

The database contains status information indicating a current status of the receiver's voice talk apparatus, and the search section searches for the receiver's voice talk apparatus with reference to status information contained in the database.

The status information indicates whether or not the receiver's voice talk apparatus is currently in use, and the search section searches for the receiver's voice talk apparatus which is not currently in use, with reference to the status information contained in the database.

The voice talk control apparatus further comprises a voice accumulating section operable to buffer a voice received by the control apparatus's reception section, a talk control section operable to establish a connection between the receiver's voice talk apparatuses grouped by the grouping section and the sender's voice talk apparatus, and a control apparatus's transmission section operable to output the voice buffered in the voice accumulating section to the network to transmit the voice to the receiver's voice talk apparatuses grouped by the grouping section, when the connection is established by the talk control section.

The sender's voice talk apparatus further comprises a release requesting section operable to output a release request signal requesting release of a connection to any of the receiver's voice talk apparatuses having an established current connection with the sender's voice talk apparatus, in response to an operation of the sender's voice talk apparatus, and the talk apparatus's transmission section further outputs the release request signal from the release requesting section to the network, the control apparatus's reception section further receives the release request signal transmitted via the network from the sender's voice talk apparatus, and the talk control section releases a connection with the receiver's voice talk apparatus designated by the release request signal received by the control apparatus's reception section.

The sender's voice talk apparatus further comprises a hold requesting section operable to output a hold request signal requesting holding of a connection to any of the receiver's voice talk apparatuses having an established current connection with the sender's voice talk apparatus, in response to an operation of the sender's voice talk apparatus, the talk apparatus's transmission section further outputs the hold request signal from the hold requesting section to the network, the control apparatus's reception section further receives the hold request signal transmitted via the network from the sender's voice talk apparatus, and the talk control section releases a connection of the receiver's voice talk apparatuses other than the receiver's voice talk apparatus designated by the hold request signal received by the control apparatus's reception section.

The talk control section further establishes a new connection between the sender's voice talk apparatus, and the receiver's voice talk apparatuses which are grouped by the grouping section after disconnection of a first connection and to which the voice buffered in the voice accumulating section is not yet transmitted, and the control apparatus's transmission section further transmits the voice buffered in the voice accumulating section to the receiver's voice talk apparatus having the new connection established by the talk control section.

The voice talk control apparatus further comprises a priority setting section operable to assign ordinal numbers as priorities for the talk control section to establish a connection, to the receiver's voice talk apparatuses grouped by the grouping section, and the talk control section establishes a first connection with the receiver's voice talk apparatus having a highest priority assigned by the priority setting section.

The priority setting section assigns the priority with reference to location information and identification information contained in the additional information.

The voice talk control apparatus further comprises a voice recognizing section operable to analyze a voice received by the control apparatus's reception section to recognize contents uttered by a user of the sender's voice talk apparatus, and the priority setting section assigns the priority with reference to a result of the recognition by the voice recognizing section.

The talk control section establishes a connection with the sender's voice talk apparatus in order of the priorities of the receiver's voice talk apparatuses assigned by the priority setting section, highest first.

The talk control section establishes a new connection when a non-voice interval continues for a predetermined time between voice talk apparatuses between which the previous connection is established.

A second aspect of the present invention is directed to a voice talk control apparatus of controlling a group talk established between a plurality of voice talk apparatuses connected via a network. The voice talk control apparatus comprises a control apparatus's reception section operable to receive a voice and additional information transmitted via the network from a sender's voice talk apparatus, a search section operable to search a database configured to search receiver's voice talk apparatuses, using at least one of the voice and the additional information received by the control apparatus's reception section, to specify at least one of the receiver's voice talk apparatuses with which the sender's voice talk apparatus can currently have a group talk, and a grouping section operable to group the at least one of the receiver's voice talk apparatuses specified by the search section, and hold at least the receiver's voice talk apparatuses registered in the group until a talk between the sender's voice talk apparatus and the receiver's voice talk apparatuses.

When the sender's voice talk apparatus can be carried in a vehicle, the additional information contains at least location information with which a current location of the sender's voice talk apparatus can be specified and identification information which is related to a user of the sender's voice talk apparatus, the location information contains at least one of the current location, a location of a destination, a movement speed, a traveling direction, and a route to the destination of the sender's voice talk apparatus, and the identification information contains at least one of a name, an age, an address, a telephone number, a mail address, a nickname, and preference information of a user of the sender's voice talk apparatus, and the search section searches for the receiver's voice talk apparatus located in a vicinity of the current location, the destination, and/or the route to the destination of the sender's voice talk apparatus, with reference to the additional information.

The database contains status information indicating a current status of the receiver's voice talk apparatus, and the search section searches for the receiver's voice talk apparatus with reference to status information contained in the database.

The status information indicates whether or not the receiver's voice talk apparatus is currently in use, and the search section searches for the receiver's voice talk apparatus which is not currently in use, with reference to the status information contained in the database.

The voice talk control apparatus further comprises a voice accumulating section operable to buffer a voice received by the control apparatus's reception section, a talk control section operable to establish a connection between the receiver's voice talk apparatuses grouped by the grouping section and the sender's voice talk apparatus, and a control apparatus's transmission section operable to output the voice buffered in the voice accumulating section to the network to transmit the voice to the receiver's voice talk apparatuses grouped by the grouping section, when the connection is established by the talk control section.

The talk control section further establishes a new connection between the sender's voice talk apparatus, and the receiver's voice talk apparatuses which are grouped by the grouping section after disconnection of a first connection and to which the voice buffered in the voice accumulating section is not yet transmitted, and the control apparatus's transmission section further transmits the voice buffered in the voice accumulating section to the receiver's voice talk apparatus having the new connection established by the talk control section.

The voice talk control apparatus further comprises a priority setting section operable to assign ordinal numbers as priorities for the talk control section to establish a connection, to the receiver's voice talk apparatuses grouped by the grouping section, and the talk control section establishes a first connection with the receiver's voice talk apparatus having a highest priority assigned by the priority setting section.

The priority setting section assigns the priority with reference to location information and identification information contained in the additional information.

The voice talk control apparatus further comprises a voice recognizing section operable to analyze a voice received by the control apparatus's reception section to recognize contents uttered by a user of the sender's voice talk apparatus, and the priority setting section assigns the priority with reference to a result of the recognition by the voice recognizing section.

The talk control section establishes a connection with the sender's voice talk apparatus in order of the priorities of the receiver's voice talk apparatuses assigned by the priority setting section, highest first.

The talk control section establishes a new connection when a non-voice interval continues for a predetermined time between voice talk apparatuses between which the previous connection is established.

A third aspect of the present invention is directed to a voice talk control method of controlling a group talk established between a plurality of voice talk apparatuses connected via a network. The voice talk control method comprises a talk starting step performed by a sender's voice talk apparatus in response to an operation for starting a group talk, a voice input step of receiving a voice input while the talk starting step is being operated, the voice input step being performed by the sender's voice talk apparatus, an additional information obtaining step of obtaining additional information required to group receiver's voice talk apparatuses, the additional information obtaining step being performed by the sender's voice talk apparatus, a transmission step of transmitting the voice received in the voice input step and the additional information obtained in the additional information obtaining step to the network, the transmission step being performed by the sender's voice talk apparatus, a reception step of receiving a voice and additional information transmitted via the network from the sender's voice talk apparatus, the reception step being performed by the voice talk control apparatus, a search step of searching a database configured to search the receiver's voice talk apparatuses, using at least one of the voice and the additional information received by the reception step, to specify at least one of the receiver's voice talk apparatuses with which the sender's voice talk apparatus can currently have a group talk, the search step being performed by the voice talk control apparatus, and a grouping step of grouping the at least one of the receiver's voice talk apparatuses specified by the search step, and holding at least the receiver's voice talk apparatuses registered in the group until a group talk between the sender's voice talk apparatus and the receiver's voice talk apparatuses is ended, the grouping step being performed by the voice talk control apparatus.

A fourth aspect of the present invention is directed to a voice talk control program of controlling a group talk established between a plurality of voice talk apparatuses connected via a network. A sender's voice talk apparatus comprises a talk starting section operable to start a group talk, a microphone operable to receive a voice input while the talk starting section is being operated, an additional information obtaining section operable to obtain additional information required to group receiver's voice talk apparatuses, and a talk apparatus's transmission section operable to transmit the voice received through the microphone and the additional information obtained by the additional information obtaining section to the network. The voice talk control program comprises a reception step of receiving the voice and the additional information transmitted via the network from the sender's voice talk apparatus, the reception step being performed by the voice talk control apparatus, a search step of searching a database configured to search the receiver's voice talk apparatuses, using at least one of the voice and the additional information received by the reception step, to specify at least one of the receiver's voice talk apparatuses with which the sender's voice talk apparatus can currently have a group talk, the search step being performed by the voice talk control apparatus, and a grouping step of grouping the at least one of the receiver's voice talk apparatuses specified by the search step, and holding at least the receiver's voice talk apparatuses registered in the group until a group talk between the sender's voice talk apparatus and the receiver's voice talk apparatuses is ended, the grouping step being performed by the voice talk control apparatus.

As described above, according to the aspects of the present invention, the voice talk control apparatus on a network responds voice data from a voice talk apparatus and holds information concerning a party on the other end of a talk which is identified by a search on behalf of the voice talk apparatus. Therefore, a user of a sender's voice talk apparatus no longer needs to previously group and register user(s) of receiver's voice talk apparatus(es), thereby eliminating a burdensome registration operation. In addition, it is not necessary to store registered data. Further, by the process of the voice talk control apparatus, until a connection with a user of a selected receiver's voice talk apparatus (es) is disconnected, a connection with users of the other receiver's voice talk apparatuses is not established. Therefore, for a certain time, the sender's voice talk apparatus has a voice communication with only a selected receiver's voice talk apparatus(es). In other words, it is possible to avoid a situation that, when the user of a sender's voice talk apparatus utters a voice, a number of persons respond substantially simultaneously. Therefore, it is possible to provide a voice talk control apparatus with which the user of a sender's voice talk apparatus readily identifies a party on the other end of a talk.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a whole structure of a voice talk system 1 according to an embodiment of the present invention;

FIG. 2 is a block diagram illustrating a detailed structure of a voice talk apparatus 11 of FIG. 1;

FIG. 3 is a block diagram illustrating a detailed structure of a voice talk control apparatus 13 of FIG. 1;

FIG. 4 is a schematic diagram illustrating a structure of a record constituting a database stored in a database storing section 133 of FIG. 3;

FIG. 5 is a sequence diagram illustrating a communication procedure of the voice talk system 1 of FIG. 1;

FIG. 6 is a flowchart illustrating a detailed procedure of a search process performed by a searching section 134 of FIG. 3;

FIG. 7 is a sequence diagram illustrating operations of the voice talk apparatus 11, the voice talk control apparatus 13, and voice talk apparatuses 12 of FIG. 1;

FIG. 8 is a sequence diagram concerning release of a connection between the voice talk apparatuses 11 and 12 of FIG. 1 after establishment of the connection;

FIG. 9 is a block diagram illustrating a detailed structure of the voice talk control apparatus 13 of FIG. 1; and

FIG. 10 is a sequence diagram illustrating a communication procedure of the voice talk system 1 of FIG. 1.

### DESCRIPTION OF THE PREFERRED EMBODIMENTS

### Embodiments

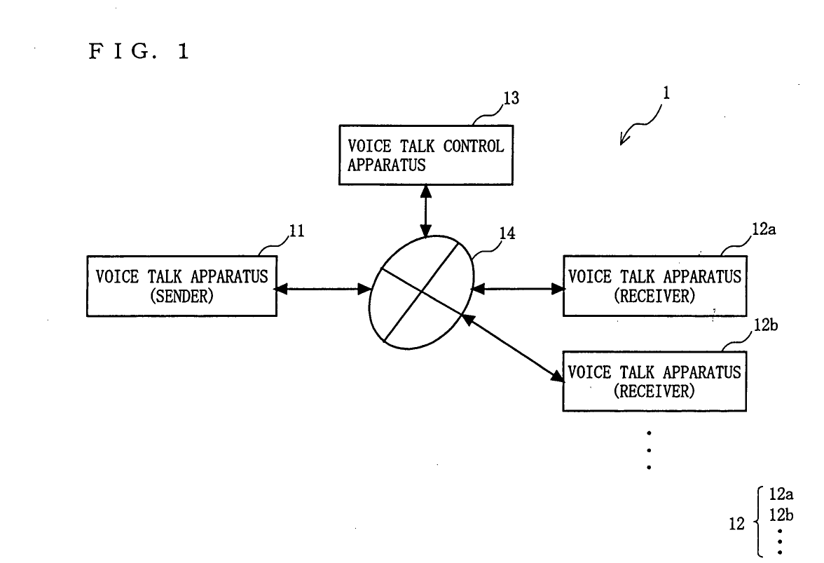

FIG. 1 is a schematic diagram illustrating a whole structure of a voice talk system 1 according to an embodiment of the present invention. In FIG. 1, the voice talk system 1 comprises a voice talk apparatus (sender) 11, at least one voice talk apparatus (receiver) 12, and a voice talk control apparatus 13. The voice talk apparatuses 11 and 12 and the voice talk control apparatus 13 are connected together via a network 14, such as the Internet and/or a cellular network, so that they can communicate with each other. Note that FIG. 1 illustrates two voice talk apparatuses 12a and 12b as the at least one voice talk apparatus (receiver) 12.

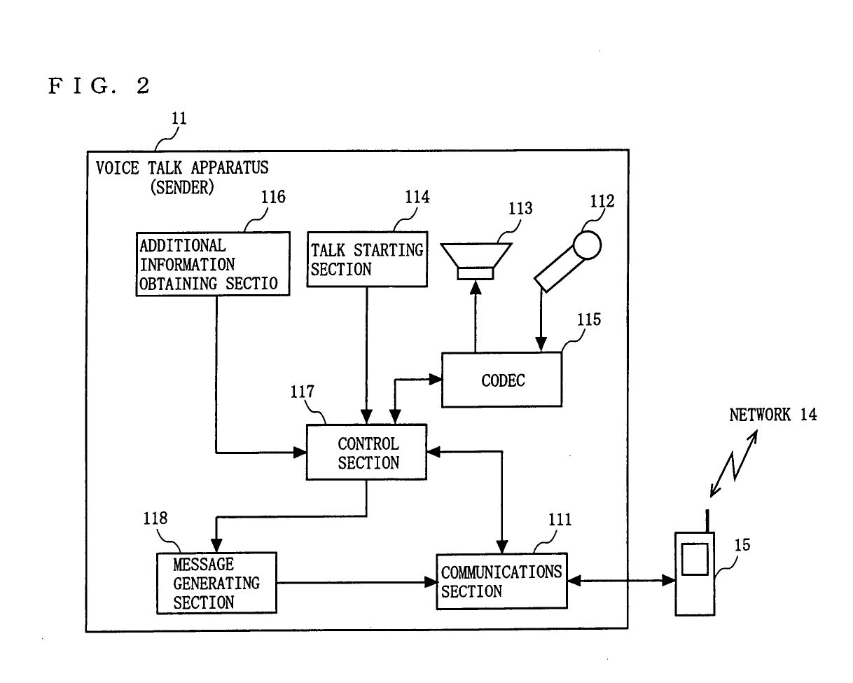

For example, the voice talk apparatus 11 is an in-vehicle terminal apparatus which is connected to a mobile telephone 15 having a hands-free function (see FIG. 2), and has a PTT (Push-to-Talk) function. An example of such an in-vehicle terminal apparatus is a navigation apparatus which can be installed in a vehicle.

For example, the voice talk apparatuses 12a and 12b are each a POS (Point Of Sale) terminal apparatus, which is installed in a facility or a shop, such as a restaurant or the like. As used herein, the term “shop” refers to a facility, a store, a restaurant, or the like. As a specific example, the voice talk apparatus 12a is installed in a shop A, while the voice talk apparatus 12b is installed in another shop B. The voice talk apparatuses 12a and 12b receive a call emitted from the voice talk apparatus 11 by means of the PTT function, and thereafter, perform a voice communication with the voice talk apparatus 11.

The voice talk control apparatus 13 is typically incorporated into a server, or a packet switching machine on a cellular network, that performs a call control. The voice talk control apparatus 13 controls a point-to-multipoint voice talk (PTT) between a user of the voice talk apparatus 11 (hereinafter referred to as a “sender's user”) and users of the voice talk apparatuses 12a and 12b (hereinafter referred to as “receiver's user”).

Next, the voice talk apparatus 11 will be described. FIG. 2 is a block diagram illustrating a detailed structure of the voice talk apparatus 11 of FIG. 1. In FIG. 2, the voice talk apparatus 11 comprises a communications section 111, a microphone 112, a loudspeaker 113, a talk starting section 114, a CODEC 115, an additional information obtaining section 116, a control section 117, and a message generating section 118.

The communications section 111 is connected to the network 14, and transmits a sender's message (described in detail below) which is generated in the voice talk apparatus 11 to the network 14, and receives a receiver's message (described in detail below) which is transmitted via the network 14.

The microphone 112 receives a user's voice, converts such an input voice into an analog voice signal, and outputs the analog voice signal to the CODEC 115. The loudspeaker 113 outputs a voice in accordance with the analog voice signal output from the CODEC 115 described below.

The talk starting section 114 is typically a PTT button. The user utters a voice toward the microphone 112 while operating the talk starting section 114. An analog voice signal generated based on the input voice is output to the CODEC 115.

The CODEC 115 converts the analog voice signal from the microphone 112 into a digital voice signal, and outputs the digital voice signal to the control section 117. The CODEC 115 also obtains, via the control section 117, a digital voice signal received by the communications section 111. The CODEC 115 further converts the obtained digital voice signal to an analog voice signal, and outputs the analog voice signal to the loudspeaker 113.

The additional information obtaining section 116 obtains additional information. The additional information includes location information with which a current location of a user can be specified, and identification information with which a user can be identified.

The location information is a current location itself, the name of a road on which a user is traveling, the name of an intersection at the current location, a location of a destination, a movement speed of the user, a traveling direction of the user, a route to the destination, or a combination of two or more selected therefrom. Note that the additional information obtaining section 116 can typically obtain such location information from a well-known navigation system.

The identification information is the name, age, address, telephone number, mail address, nickname, or preference information of a user, or a combination of two or more selected therefrom. Such identification information is stored in the voice talk apparatus 11 itself or a storage apparatus (not illustrated) connected to the voice talk apparatus 11. Note that it is preferable that the voice talk apparatus 11 perform a control so that a portion of the identification information is not transmitted to an unspecified voice talk apparatus 12. Specifically, the voice talk apparatus 11 performs a control so that only an item(s) which the user previously permits (e.g., a nickname) is transmitted to an unspecified voice talk apparatus 12.

The control section 117 is composed of, for example, a CPU, a ROM, and a RAM, and controls each component of the voice talk apparatus 11.

The message generating section 118 initially obtains, via the control section 117, a digital voice signal output from the CODEC 115. The message generating section 118 also obtains, via the control section 117, additional information output from the additional information obtaining section 116. The message generating section 118 basically generates a sender's message containing at least the obtained digital voice signal and additional information, and outputs the sender's message to the communications section 111. Specifically, the sender's message contains a digital voice signal indicating a search content.

Next, the voice talk apparatus 12 will be described. Each voice talk apparatus 12 is connected to the network 14 and is capable of performing a PTT-based talk. The voice talk apparatus 12 also transmits a receiver's message generated therein to the network 14, in a manner similar to that of the voice talk apparatus 11. Here, the receiver's message contains a digital voice signal indicating spoken word(s) of the user of the voice talk apparatus 12. The voice talk apparatus 12 also receives, via the network 14, a digital voice signal contained in a sender's message output from the voice talk apparatus 11. The voice talk apparatus 12 processes the received digital voice signal in a manner similar to that of the voice talk apparatus 11, thereby outputting a voice indicated by the voice signal.

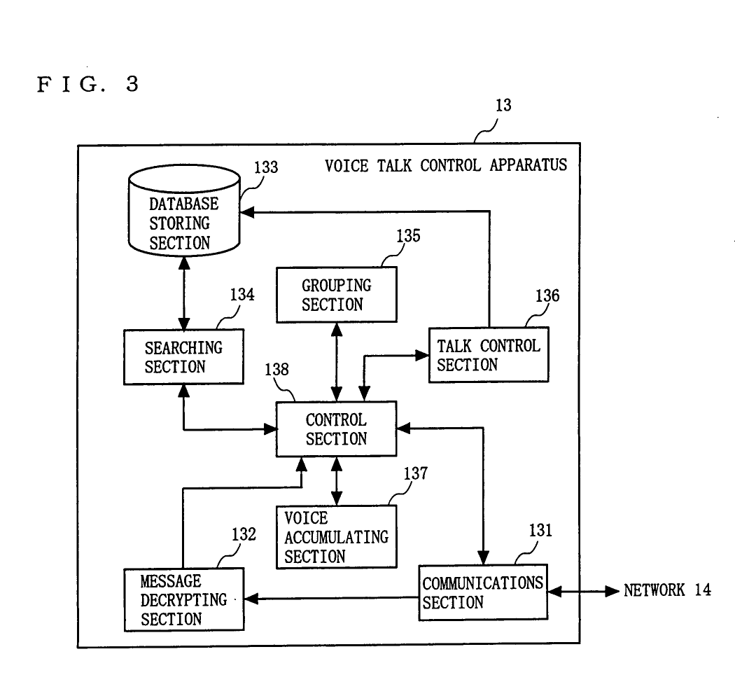

Next, the voice talk control apparatus 13 will be described. FIG. 3 is a block diagram illustrating a detailed structure of the voice talk control apparatus 13 of FIG. 1. In FIG. 3, the voice talk control apparatus 13 comprises a communications section 131, a message decrypting section 132, a database storing section 133, a searching section 134, a grouping section 135, a talk control section 136, a voice accumulating section 137, and a control section 138.

The communications section 131 is connected to the network 14, and receives, via the network 14, the sender's message transmitted from the voice talk apparatus 11 and the receiver's message transmitted from the voice talk apparatus 12.

The message decrypting section 132 obtains the sender's message received by the communications section 131, and extracts a digital voice signal and additional information contained in the sender's message. The extracted digital voice signal and additional information are transferred to the control section 138.

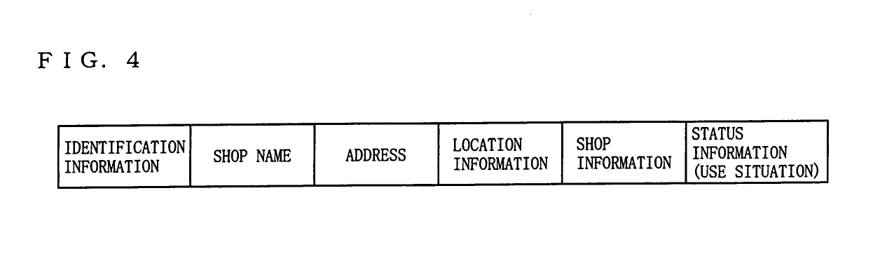

The database storing section 133 stores a database containing various information concerning each voice talk apparatus 12 connected to the network 14. FIG. 4 is a schematic diagram illustrating a structure of a record constituting the database. In FIG. 4, as an illustrative example, a record is assigned to each voice talk apparatus 12, and contains identification information, a shop name, an address, location information, shop information, and status information.

The identification information can be used to uniquely identify a corresponding voice talk apparatus 12.

The shop name is the name of a shop when a voice talk apparatus 12 of interest is installed in the shop.

The address is information required for a grouping process (described in detail below) which is performed before the voice talk apparatus 11 performs a PTT-based voice talk with the voice talk apparatus 12. Examples of such information include a group ID, an IP (Internet Protocol) address, an URI (Uniform Resource Identifier), or a telephone number which are assigned to a voice talk apparatus 12 of interest.

The location information is information indicating a location at which a voice talk apparatus 12 of interest is installed.

The shop information is information indicating a service which, when a voice talk apparatus 12 of interest is installed in a shop, the shop can offer to the user of the voice talk apparatus 11. Such shop information preferably contains outline information roughly indicating service(s) which can be offered by the shop and detailed information specifically indicating the service(s). For example, the outline information includes “eating and drinking place”, while the detailed information includes “Chinese cuisine restaurant” or “French cuisine restaurant”. Note that the outline information and the detailed information are not particularly illustrated in FIG. 4.

The status information is information indicating whether or not a PTT-based voice talk is being currently performed by a voice talk apparatus 12 of interest. Specifically, when a connection has been established between the voice talk apparatus 12 and the voice talk apparatus 11, the status information is set to be “in use (busy line)”. Conversely, when the connection is released, the status information is set to be “usable”. In addition, the status information may include information indicating that a voice talk apparatus 12 of interest is not powered ON.

A plurality of such records constitute a database. Although, for the sake of simplicity, it is described in this embodiment that one record is assigned to one voice talk apparatus 12, one record may be assigned to a plurality of voice talk apparatuses 12.

Referring back to FIG. 3, the searching section 134 searches for identification information stored in the database storing section 133 using, as a key word, a search content included in the digital voice signal extracted by the message decrypting section 132. Preferably, the searching section 134 further uses additional information transmitted along with the search content so as to search the database.

The grouping section 135 uses at least one of the search content and the additional information contained in the sender's message to group and hold identification information (i.e., receiver's user(s) with who the sender's user can currently talk) which has been retrieved by the searching section 134.

The talk control section 136 establishes a connection for performing a push-to-talk between the sender's user and the receiver's users grouped together by the grouping section 135. The talk control section 136 uses a call control protocol (signaling protocol), such as SIP (Session Initiation Protocol), to establish a connection between the voice talk apparatus 11 sending the search content and the voice talk apparatus 12 found in the database. After establishment of a connection, the voice talk apparatus 11 and the voice talk apparatus 12 perform a PTT-based voice communication directly without via the voice talk control apparatus 13. The talk control section 136 can also monitor the voice communication. Specifically, the talk control section 136 sets the status information of a record assigned to the voice talk apparatus 12 of interest to be “in use” when the connection has been established, and “usable” when the connection has been released.

The voice accumulating section 137 accumulates a digital voice signal extracted from a sender's message. The control section 138 is, for example, composed of a CPU, a ROM, and a RAM, and controls each component of the voice talk control apparatus 13 in accordance with a computer program previously stored in the ROM.

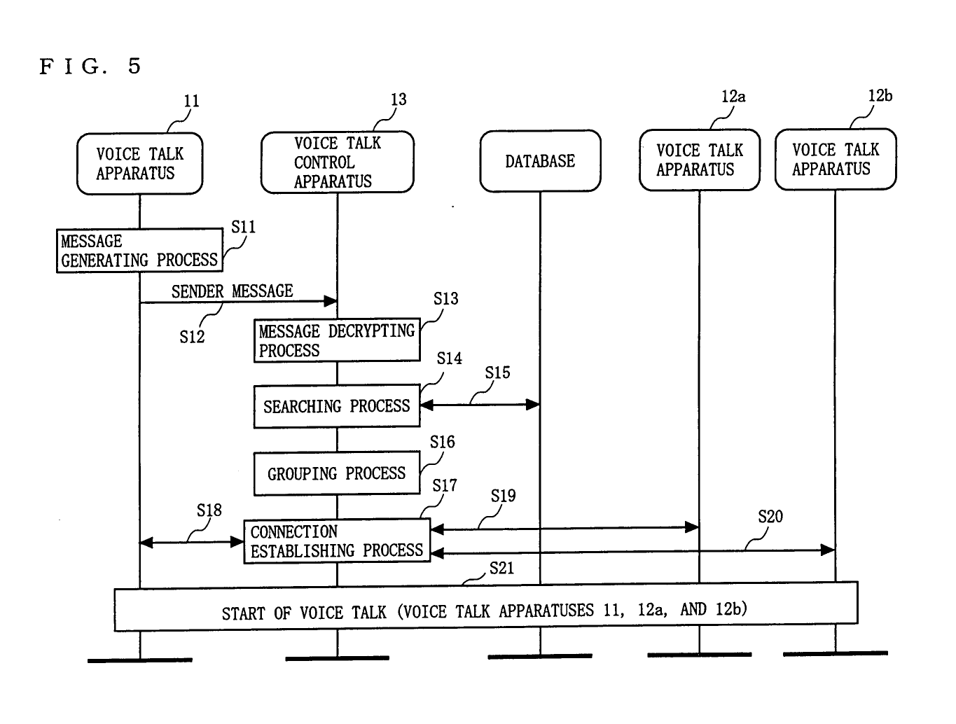

Next, an operation of the voice talk system of this embodiment will be described with reference to the drawings. FIG. 5 is a sequence diagram illustrating operations of the voice talk apparatus 11, the voice talk control apparatus 13, and the voice talk apparatus 12 in the voice talk system of this embodiment, until a voice talk is started between a sender's user and a receiver's user.

Initially, in the voice talk apparatus 11, the message generating section 118 generates a sender's message (sequence S11). A first sender's message contains, at least, a digital voice signal and additional information indicating a search content as described above. The sender's message generated in sequence S11 is transmitted via the communications section 111 and the mobile telephone 15 to the network 14, and is transferred to the voice talk control apparatus 13 (sequence S12).

In the voice talk control apparatus 13, the message decrypting section 132 decrypts the currently received sender's message to obtain a digital voice signal and additional information contained therein (sequence S13). Further, the message decrypting section 132 obtains a search content from the digital voice signal. The digital voice signal is stored into the voice accumulating section 137. The search content and the additional information are transferred to the searching section 134.

Next, the searching section 134 uses at least one of the received search content and additional information to search the database stored in the database storing section 133 (sequences S14 and S15). By the search, a candidate receiver's user (i.e., a voice talk apparatus 12) with which the sender's user currently wishes performing a voice talk, is selected. For example, when the search content indicates that the sender's user wishes eating Chinese cuisine and the additional information indicates the current location of the sender's user, the searching section 134 checks shop information and location information in the database, and retrieves at least one record which is assigned to a Chinese cuisine restaurant located in the vicinity of the current location of the sender's user. Note that, since the PTT-based voice talk allows broadcast communication, a plurality of records are preferably retrieved. Further, preferably, in the search process, the searching section 134 checks status information so as to search for records whose status information is set to be “usable”, but not records whose status information is set to be “not usable”.

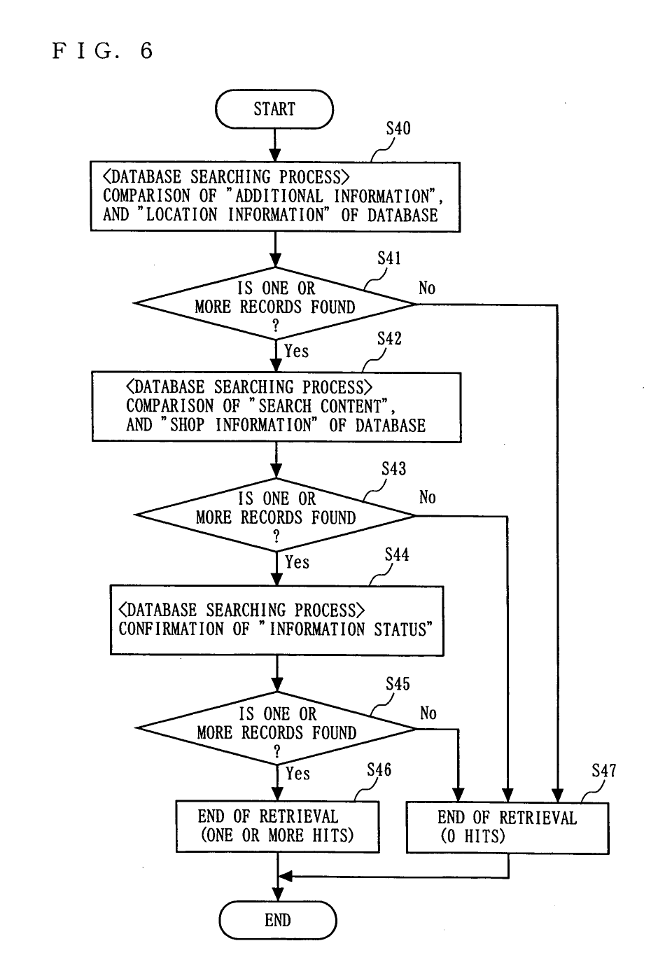

FIG. 6 is a flowchart illustrating a detailed procedure of the search process performed by the searching section 134. Note that the search process will be hereinafter described, assuming that the search content indicates “I like eating Chinese cuisine” and the additional information indicates the current location of the sender's user.

Initially, the searching section 134 compares a “location information” field in the database with the additional information so as to search for all shops which are located in the vicinity of the current location of the sender's user (step S40). When one or more records are found in this search (Yes in step S41), the searching section 134 goes to step S42. When no record is found (No in S41), the searching section 134 goes to step S47, extraction is completed (0 hits), and the process is ended.

In step S42, the search content is compared with the “shop information” field of the record(s) found in step S41 to search for the records of shops which satisfy conditions for “Chinese cuisine” which is the search request. When one or more records are present (Yes in step S43), the searching section 134 goes to step S44. Conversely, when no record is found (No in step S43), the searching section 134 goes to the above-described step S47.

Next, the searching section 134 checks the status information of the record(s) thus found to search for records whose status information is set to be “usable” (step S44). When one or more such records are present (Yes in step S45), the searching section 134 goes to step S46. When extraction of one or more receiver's users which are on the other end of a current talk (step S46), the process is ended. Conversely, when no record is found (No in step S45), the searching section 134 goes to S47.

Although the search process is performed in order of steps S40→S42→S44 in the foregoing description, this order may be changed. Alternatively, these steps may be simultaneously performed.

In the foregoing description, the additional information is assumed to be a current location, but is not limited to this. For example, the additional information may be a current location, the name of a road on which a user is currently traveling, the name of an intersection at the current location, the location of a destination, a movement speed of the user, a traveling direction of the user, a route to the destination, or a combination of two or more selected therefrom. In such a case, the searching section 134 uses these pieces of additional information to search the database for receiver's users who are present in the vicinity of the current location of the voice talk apparatus 11 (sender's user), in the vicinity of the destination, and/or in the vicinity of the route to the destination. Alternatively, when the voice talk apparatus 11 is provided in an in-vehicle navigation apparatus, it is determined whether a vehicle is traveling in a city or in a suburb, and a search area can be narrowed in the case of the city or enlarged in the case of the suburb. Receiver's user(s) can be searched for within an area currently displayed on a screen of the in-vehicle navigation apparatus. Further, when the number of receiver's users found in the current search is small, the searching section 134 can search for receiver's users in a larger area in the next search. Conversely, when the number of receiver's users found in the current search is large, the searching section 134 can perform a search in a gradually reduced search area.

It is here assumed that the number of records found in the above-described current search process is two, and the voice talk apparatuses 12a and 12b are installed in shops to which these records are assigned.

Next, the grouping section 135 groups and holds the voice talk apparatus 11 which currently sends the sender's message and the voice talk apparatuses 12 which are currently found (sequence S16).

Further, the talk control section 136 establishes a connection for performing a PTT-based voice communication between the voice talk apparatus 11 and the voice talk apparatuses 12 which have been grouped together in sequence S16 (sequences S17 to S20). Thereafter, the sender's user uses the voice talk apparatus 11 and the receiver's user uses the voice talk apparatuses 12, whereby a voice talk is started (sequence S21). Under the above-described assumption, a connection is established between the voice talk apparatus 11 and the voice talk apparatuses 12a and 12b, and a voice communication is started therebetween.

When a connection is established, the grouped voice talk apparatuses 12 are in a voice communication. The talk control section 136 sets the status information of the records in the database of the voice talk apparatuses 12 starting the voice communication to be “in use”. As described above, the talk control section 136 can monitor the voice communication between the voice talk apparatus 11 and the voice talk apparatuses 12. Therefore, when the voice communication is ended, the talk control section 136 also sets the status information of the records of interest to be “usable”.

Note that, when no record is found in the search process in sequence S14, the voice talk control apparatus 13 may connect to a predetermined site, such as a concierge service (a real person operator in a car information service). In this case, an operator who has best knowledge of a search content which is uttered by the sender's user is grouped with the sender's user.

After grouping is performed by the grouping section 135 and before a connection is established, the voice talk control apparatus 13 may inquire, with respect to the sender's user, whether or not to perform a voice talk with a receiver's user found by the search. Thereby, the sender's user can refuse a voice talk. In this case, the voice talk control apparatus 13 does not perform the connection establishing process (sequences S17 to S20).

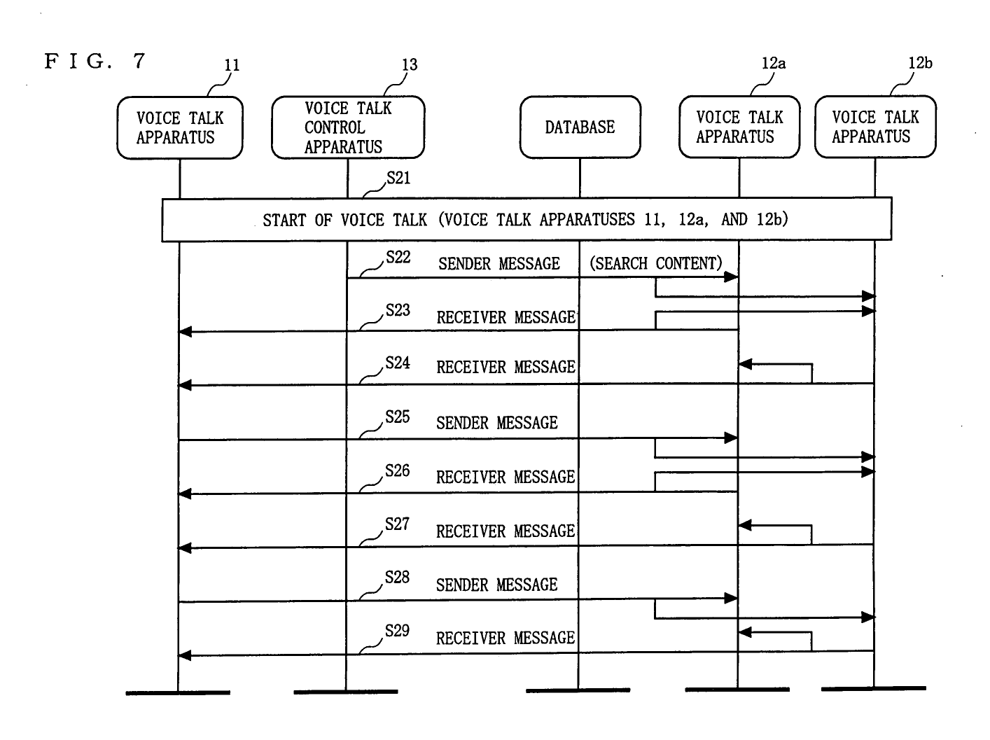

A description will be given of a voice communication performed between the voice talk apparatus 11, the voice talk apparatus 12, and the voice talk control apparatus 13 after the connection establishing process as described above is performed. FIG. 7 is a sequence diagram illustrating operations of the voice talk apparatus 11, the voice talk control apparatus 13, and the voice talk apparatus 12 of FIG. 1 after the connection establishing process is performed.

Initially, as described above, the sender's user inputs a voice indicating a search content into the microphone 112 while operating the talk starting section 114 of the voice talk apparatus 11. An illustrative example of a voice indicating a search content is “I like eating Chinese cuisine”. In response to this, the voice talk apparatus 11 generates a first sender's message as described with reference to FIG. 5. Also, the voice talk control apparatus 12 accumulates a digital voice signal contained in the sender's message into the voice accumulating section 137. Further, the sender's message is used to search for receiver's users with which the sender's user should currently talk, as described with reference to FIG. 5, and a connection is established between the voice talk apparatuses 11 and 12.

Thereafter, as illustrated in FIG. 7, the voice talk control apparatus 13 transmits a digital voice signal stored in the voice accumulating section 137 thereof to the voice talk apparatuses 12a and 12b (sequence S22). When receiving such a digital voice signal, the receiver's user of the voice talk apparatus 12a and the receiver's user of the voice talk apparatus 12b each independently respond to this. The voice talk apparatuses 12a and 12b each transmit a receiver's message indicating a response content. The receiver's message output from the voice talk apparatus 12a is transmitted to the voice talk apparatuses 11 and 12b (sequence S23). Also, the receiver's message output from the voice talk apparatus 12b is transmitted to the voice talk apparatuses 11 and 12a (sequence S24).

In responds to each receiver's message, the sender's user inputs a response into the voice talk apparatus 11. In response to this, the voice talk apparatus 11 generates another sender's message based in the input response, and transmits the sender's message to the voice talk apparatuses 12a and 12b (sequence S25). Thereafter, similar sequences are repeated until the voice talk is ended (sequences S26 to S29).

As described above, according to the voice talk system of this embodiment, the voice talk control apparatus 13 on the network 14 responds to a first sender's message from the voice talk apparatus 11, and uses at least one of a search content and additional information contained therein to search for receiver's users. The voice talk control apparatus 13 groups and holds receiver's user(s) found in this search and the sender's user. Therefore, the sender's user does not need to previously group and register receiver's users to talk with, in the voice talk apparatus 11, thereby being freed from a burdensome registration operation. Also, it is no longer necessary to store registered data.

In the foregoing description, the search content is exemplified as “I like eating Chinese cuisine”. The present invention is not limited to this. For example, when the search content is “emergency report”, ambulance(s) and police vehicle(s) present in the vicinity of the sender's user may be grouped together and may be talked directly. Thereby, when it is necessary to take urgent measures in the case of occurrence of an accident or the like, quicker measures can be taken than when calling an emergency report center.

Note that a receiver's message from one voice talk apparatus 12 is delivered to other voice talk apparatus(es) 12, and therefore, the receiver's users may not always talk with the sender's user, leading to confusion between them. Therefore, exchange of a receiver's message may be forbidden between the voice talk apparatuses 12. Specifically, a point-to-multipoint transmission is performed from a sender's user to receiver's users, while a point-to-point transmission is performed from each receiver's user to the sender's user.

When the voice talk apparatus 11 is incorporated in an in-vehicle navigation apparatus, the in-vehicle navigation apparatus can obtain the location information of a receiver's message, search for a route from the current location to the shop of the receiver's user, and guide the sender's user to the shop of the receiver's user.

In the above-described embodiment, it has been described that the voice talk apparatus 12 has a structure similar to that of the voice talk apparatus 11 and performs a process similar thereto. The present invention is not limited to this. For example, when the voice talk apparatus 12 has a short-distance wireless communication protocol, such as typically Bluetooth(R), a plurality of headsets can support a voice talk via the voice talk apparatus 12. In other words, the headsets are each a subsidiary unit with respect to the voice talk apparatus 12 as a base unit. In this case, the status information of each headset which can access the voice talk apparatus 12 is added to a corresponding record in a database.

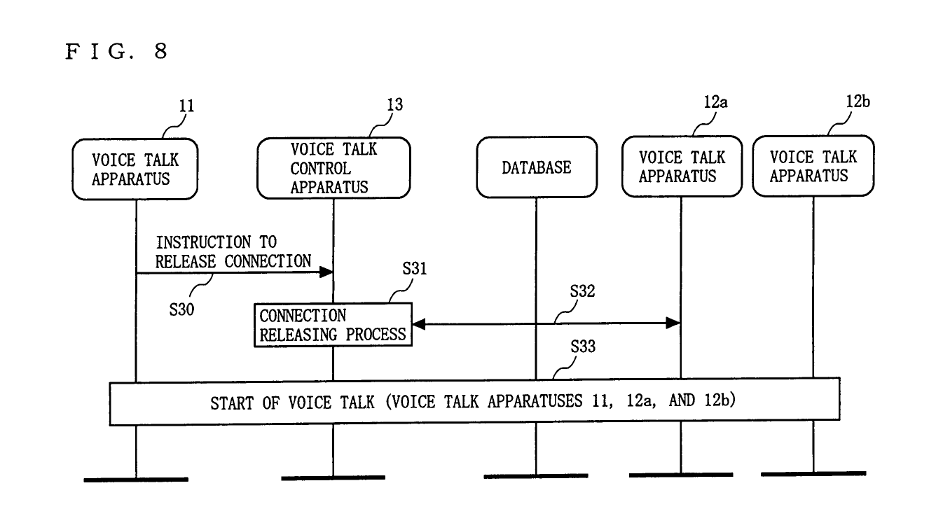

Preferably, the voice talk apparatus 11 also comprises an input device which outputs a release request signal for releasing a connection with respect to any one or more of the voice talk apparatuses 12 currently having an established connection, in repose to an operation by the sender's user. In this case, when the sender's user operates the input device of interest, the voice talk apparatus 11 outputs, via the communications section 111, the release request signal from the input device to the network 14, and the release request signal is transferred to the voice talk control apparatus 13, as illustrated in FIG. 8 (sequence S30). In the voice talk control apparatus 13, the communications section 131 receives the release request signal transmitted via the network 14. The talk control section 136 releases a connection with a voice talk apparatus 12 (12a) designated by the release request signal received by the communications section 131 (sequences S31 and S32). Thereby, the voice talk apparatus 11 continues a voice communication with the other voice talk apparatus (es) 12 (12b) whose connection is not currently released (sequence S33).

In addition, preferably, the voice talk apparatus 11 comprises an input device which outputs a hold request signal for requesting holding of a connection with respect to only any of the voice talk apparatuses 12 which currently have an established connection, in response to an operation by the sender's user. In this case, when the sender's user operates the input device of interest, the voice talk apparatus 11 outputs, via the communications section 111, the hold request signal from the input device to the network 14, the hold request signal is transferred to the voice talk control apparatus 13. In the voice talk control apparatus 13, the talk control section 136 releases a connection with voice talk apparatus(es) 12 other than the voice talk apparatus (es) 12 designated by the hold request signal currently received by the communications section 131. Thereby, the voice talk apparatus 11 continues a voice communication with the voice talk apparatus(es) 12 other than those whose connection is currently released.

With the above-described two methods, the sender's user can discontinue a voice talk with a receiver's user with who the sender's user no longer needs to talk.

Further, the voice talk control apparatus 13 may monitor a voice communication between the voice talk apparatuses 11 and 12. When the transfer of a digital voice signal therebetween ceases, i.e., a non-voice interval occurs for a predetermined time, it may be determined that a talk is ended, and a connection may be automatically released.

Also, when the voice talk apparatus 11 is incorporated in an in-vehicle navigation apparatus, a connection with a voice talk apparatus 12 of interest may be held until the sender's user reaches a destination set from the shop information of the voice talk apparatus 12, and the connection may be automatically released when the sender's user reaches the destination.

On the other hand, when the voice talk apparatus 11 is a mobile apparatus, a voice talk apparatus 12 belonging to a group may become inappropriate as a party on the other end of a talk with the sender's user over time, i.e., as the voice talk apparatus 11 is moved. For example, assuming that a search content is “I like eating Chinese cuisine” and additional information is a current location, when the sender's user has already left a location which was a current location at the time of search and is distant from the location, the sender's user may still continue to perform a voice talk with a receiver's user which was grouped in the vicinity of the current location at the time of search. To avoid such a situation, the voice talk control apparatus 13 receives additional information at regular time intervals from the voice talk apparatus 11 during a voice talk, thereby making it possible to release a connection established between the grouped voice talk apparatuses 11 and 12 and perform regrouping. Thereby, a group can be maintained appropriate to the location of the voice talk apparatus 11 which varies from time to time.

In the foregoing embodiment, the PTT-based voice talk apparatus 11 has been described, assuming the talk starting section 114 is a button. The present invention is not limited to this. A talk may be started in accordance with a voice input.

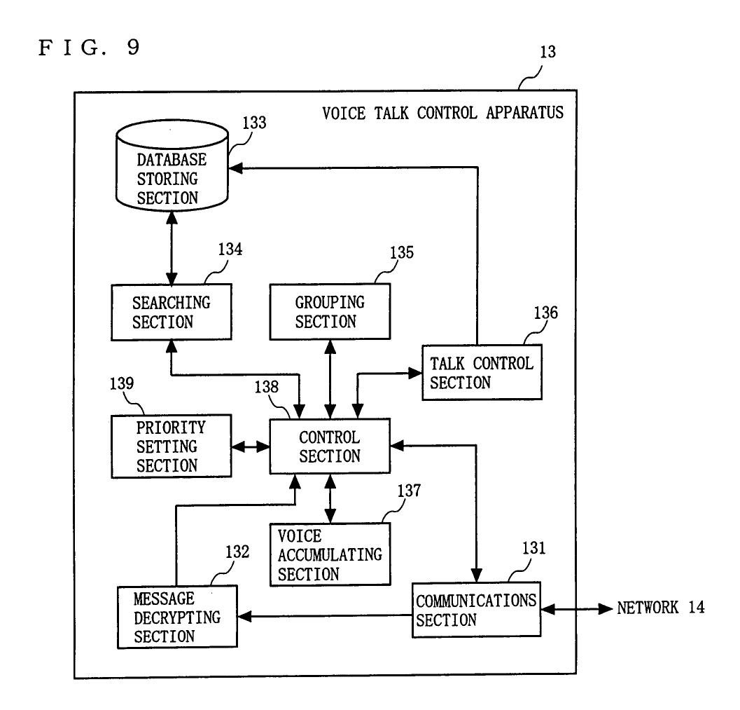

Also, as illustrated in FIG. 9, the voice talk control apparatus 13 may further comprise a priority setting section 139. When a plurality of voice talk apparatuses 12 are grouped together, the priority setting section 139 determines the order (i.e., priorities) of the voice talk apparatuses 12 in which a digital voice signal is transferred thereto.

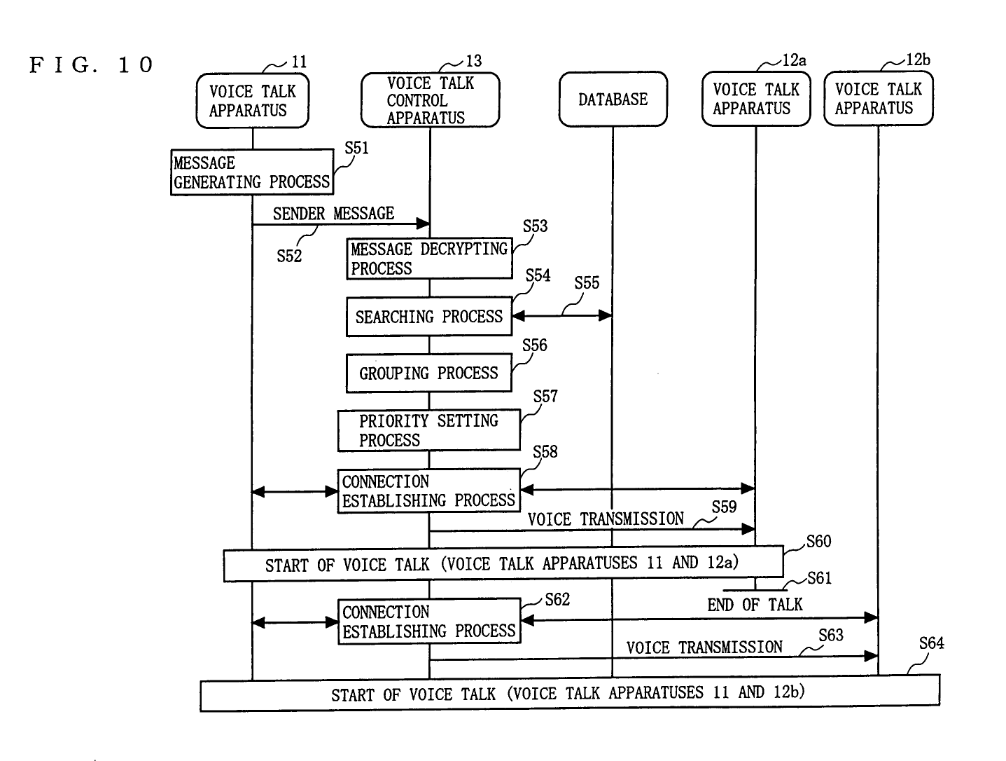

Next, an exemplary procedure of a communication between the voice talk apparatus 11 and each voice talk apparatus 12 in the voice talk system 1 thus configured will be described. FIG. 10 is a sequence diagram illustrating an exemplary voice communication in the voice talk system 1. In the example of FIG. 10, the sender's user directly calls restaurant(s) of interest using the PTT function of the voice talk apparatus 11 so as to find those located in the vicinity of the current location of the sender's user.

Initially, in the voice talk apparatus 11, the message generating section 118 generates a sender's message (sequence S51). The sender's message contains a digital voice signal and additional information which are generated from a voice input by the user. Under the above-described assumption, the additional information includes location information with which the current location of the user can be specified, and identification information with which the user can be identified.

The communications section 111 obtains the sender's message generated in sequence S51 from the message generating section 118, and outputs the sender's message to the network 14 (sequence S52).

In the voice talk control apparatus 13, the communications section 131 receives the sender's message transmitted via the network 14 from the voice talk apparatus 11. The communications section 131 transfers the received message to the message decrypting section 132. The message decrypting section 132 decrypts the currently received sender's message to obtain the digital voice signal and the additional information contained therein (sequence S53). Further, the message decrypting section 132 obtains a search content from the digital voice signal. The digital voice signal is stored into the voice accumulating section 137. The search content and the additional information are transferred to the searching section 134. Further, the additional information is transferred to the priority setting section 139.

Next, the searching section 134 uses at least one of the received search content and additional information to search a database stored in the database storing section 133 (sequences S54 and S55). By the search, the sender's user selects candidate receiver's user(s) (i.e., the voice talk apparatus(es) 12) with which the sender's user is to have a current voice talk. Next, the grouping section 135 groups and holds the voice talk apparatus 11 which has sent the current sender's message and the currently-found voice talk apparatus(es) 12 (sequence S56).

Next, the priority setting section 139 assigns priority to the voice talk apparatuses 12 grouped together in sequence S56, based on the received additional information (sequence S57). When the additional information contains the current location of the sender's user as assumed above, the priority setting section 139 assigns priorities to the voice talk apparatuses 12 using location information included in various information of each voice talk apparatus 12 stored in the database storing section 133. For example, the priority setting section 139 assigns a higher priority to a voice talk apparatus 12 which is located closer to the current location of the sender's user. Further, in this embodiment, it is assumed that the voice talk apparatus 12a is located closer to the voice talk apparatus 11 (sender) than the voice talk apparatus 12b is. Under this assumption, a higher priority is applied to the voice talk apparatus 12a while a lower priority is assigned to the voice talk apparatus 12b.

When sequence S57 is ended, the control section 138 obtains information concerning the voice talk apparatus 12 to which the highest priority is assigned by the priority setting section 139. Further, the control section 138 informs the talk control section 136 of the obtained information concerning the voice talk apparatus 12 and a digital voice signal stored in the voice accumulating section 137. The talk control section 136 establishes a connection required for a voice communication between the voice talk apparatus 12 currently informed and the voice talk apparatus 11 (sender) (sequence S58). Further, the talk control section 136 outputs the digital voice signal to the network 14 immediately after the establishment of the connection. Thereby, the digital voice signal is transmitted to the voice talk apparatus 12 (sequence S59). Thereby, a PTT-based voice talk is started between both the users (sequence S60). Under the above-described assumption, the digital voice signal output from the voice talk apparatus 11 is transmitted to the voice talk apparatus 12a to which the higher priority has been assigned, and a voice talk is started between the users of the voice talk apparatuses 11 and 12a. Thereby, the user of the voice talk apparatus 11 can inquire various things about the shop or facility from the user of the voice talk apparatus 12a. On the other hand, at the current stage, the digital voice signal is not transmitted to the voice talk apparatus 12b, so that a PTT-based voice talk is not started between the users of the voice talk apparatus 11 and 12b.

As described above, according to the voice talk control apparatus 13 of this embodiment, at the current time, the talk control section 136 establishes a connection between a single voice talk apparatus 12 (the voice, talk apparatus 12a under the above-described assumption) which is first selected by the priority setting section 139, and the voice talk apparatus 11. Further, the talk control section 136 transmits a voice signal output from the voice talk apparatus 11 to only the single selected voice talk apparatus 12 (12a). Therefore, at the current time, the other voice talk apparatus (es) 12 (the voice talk apparatus 12b under the above-described assumption) do not receive a voice signal transmitted from the voice talk apparatus 11. Thereby, at the current time, the sender's user can perform a PTT-based voice talk with the single receiver's user, and does not receive a response from the other receiver's user(s), thereby making it easier to identify the user on the other end of the talk.

When, as a result of the talk with receiver's user selected first, the sender's user decides to go to a place where the currently selected voice talk apparatus 12 (12a) is installed, the sender's user finishes the business and does not require a further voice talk. In this case, the voice talk apparatus 11 generates a sender's message indicating that the business is finished (not illustrated), and transmits the message via the network 14 to the voice talk control apparatus 13. In response to this, the voice talk control apparatus 13 disconnects the connection between the voice talk apparatuses 11 and 12 (12a), and further discards various information generated in a series of current processes, such as the voice signal from the voice talk apparatus 11.

Also, in the case where the sender's user made the above-described decision, when the voice talk apparatus 11 is incorporated in a navigation apparatus or when the voice talk apparatus 11 can communicate with a navigation apparatus, the navigation apparatus can guide the sender's user to a place where the voice talk apparatus 12 (12a) is installed.

On the other hand, when the sender's user determines that the sender's user needs a further voice talk, the voice talk apparatus 11 generates a sender's message indicating the determination so as to request establishment of another connection, and outputs the message via the network 14 to the voice talk control apparatus 13. Further, the voice talk apparatus 11 generates a sender's message indicating that the business is finished, and transmits the message via the network 14 to the voice talk control apparatus 13.

In response to the above-described sender's message, the talk control section 136 disconnects the connection which has been established between the voice talk apparatuses 11 and 12 (12a) (sequence S61).

Thereafter, the control section 138 obtains information concerning a voice talk apparatus 12 to which a second highest priority is assigned, from the priority setting section 139. Further, the control section 138 informs the talk control section 136 of the obtained information concerning the voice talk apparatus 12 and a digital voice signal stored in the voice accumulating section 137. The talk control section 136 establishes a connection required for a voice communication between the currently informed voice talk apparatus 12 and the voice talk apparatus 11 (sender) (sequence S62). Further, the talk control section 136 transmits the digital voice signal to the network 14 immediately after the establishment of the connection. Thereby, the digital voice signal is transmitted to the voice talk apparatus 12 (sequence S63). Thereby, a PTT-based voice talk is started between both the users (sequence S64). The subsequent processes are similar to those performed in the case of the voice talk apparatus 12a and will not be explained.

Under the above-described assumption, the digital voice signal output from the voice talk apparatus 11 is transmitted to the voice talk apparatus 12b to which the second priority is assigned, and a voice talk is started between the users of the voice talk apparatuses 11 and 12b. Thereby, the sender's user can inquire various things about the shop or facility from the new receiver's user. Also in this case, the digital voice signal is not transmitted to voice talk apparatuses other than the voice talk apparatus 12b, so that a voice of the sender's user is not delivered to users other than the new receiver's user.

As described above, according to the voice talk control apparatus 13 of this embodiment, by the process of the voice talk control apparatus 13 on the network 14, until the connection with the single sender's voice talk apparatus 12 is disconnected, a connection is not established with respect to the other voice talk apparatus(es) 12. Therefore, at a certain time, the voice talk apparatus 11 performs a voice communication with only a single voice talk apparatus 12. In other words, it is possible to provide a voice talk control apparatus 13 which can avoid simultaneous responses by a plurality of persons even if a sender's user utter a voice using the PTT function, thereby allowing the sender's user to readily identify a person on the other end of a talk.

Note that, in the above-described embodiment, as a preferable example, it is assumed that a higher priority is assigned to a voice talk apparatus 12 closer to a sender's voice talk apparatus 11. The present invention is not limited to this. Alternatively, the voice talk control apparatus 13 may assign priorities to a plurality of voice talk apparatuses 12 based on the identification information of a sender's user contained in a sender's message.

Further, the voice talk control apparatus 13 may select one from a plurality of voice talk apparatuses 12 at random before establishing a connection, and establishes a connection between the currently selected voice talk apparatus 12 and the voice talk apparatus 11.

In the above-described embodiment, the voice talk control apparatus 13 disconnects a connection when receiving a predetermined sender's message from the voice talk apparatus 11. The present invention is not limited to this. Alternatively, when not detecting a voice for a predetermined time between the voice talk apparatuses 11 and 12 between which a current connection is established, the voice talk control apparatus 13 may disconnect such a connection.

Also in the above-described embodiment, it has been described that a voice signal is transmitted to the voice talk apparatus 12. The present invention is not limited to this. Alternatively, additional information may be transmitted to the voice talk apparatus 12. Thereby, the voice talk apparatus 12 can display the additional information on a display provided therein. Thereby, the voice talk apparatus 12 can obtain the location information and the identification information of the user.

Also, the priority set in the above-described embodiment may be updated at regular time intervals. Thereby, a highest priority can be assigned to a voice talk apparatus 12 closest to a current location, depending on movement of the voice talk apparatus 11. In addition, by lowering the priority of a voice talk apparatus 12 of a receiver's user which starts a talk with another sender's user, it is possible to prevent assignment of a high priority to a party which cannot have a talk with a sender's voice talk apparatus 11.

Further, in some cases, it is preferable that the voice talk control apparatus 13 do not establish a connection with a voice talk apparatus 12 to which a priority lower than a predetermined reference value is assigned. Thereby, for example, it is possible to prevent establishment of a connection between a voice talk apparatus 12 which is significantly distant from the voice talk apparatus 11, and establishment of a connection with a voice talk apparatus 12 which is installed in a shop or a facility which is not a favorite of the sender's user.

Also, the voice talk control apparatus 13 may comprise a speech recognizing section (not illustrated) which analyzes a voice signal from the voice talk apparatus 11 to recognize contents uttered by a sender's user. In this case, the priority setting section 139 can assign a priority, depending on the uttered contents.

Also in the above-described embodiment, it has been described that the voice talk apparatus 11 performs a voice communication with a single voice talk apparatus 12 for a certain time. The present invention is not limited to this. Alternatively, the voice talk control apparatus 13 may establish a connection between a predetermined small number of voice talk apparatuses 12 and the voice talk apparatus 11 as long as a smooth talk can be performed between the sender and the receivers.

Also in the above-described embodiment, it has been described that the voice talk apparatus 11 is an in-vehicle terminal apparatus connected to a mobile telephone. The present invention is not limited to this. Alternatively, the voice talk apparatus 11 may be a mobile telephone itself, or an in-vehicle terminal apparatus having a mobile telephone function. Similarly, it has been described that the voice talk apparatus 12 is a POS terminal apparatus. The present invention is not limited to this. The voice talk apparatus 12 may be either a terminal apparatus which can be carried, or a stationary terminal apparatus.

Also, it has been described that the voice talk apparatus 11 is a sender's apparatus and the voice talk apparatus 12 is a receiver's apparatus. The present invention is not limited to this. The voice talk apparatuses 11 and 12 each have both sender's and receiver's functions.

Note that the control section 138 performs the process in accordance with the computer program previously stored in a ROM as described above. The present invention is not limited to this. The above-described process may be implemented by hardware. The computer program may be distributed in the form of a recording medium (e.g., a CD-ROM) storing it. Alternatively, the computer program may be stored in a server apparatus connected to a network, in a manner which allows a terminal apparatus to download it.

While the invention has been described in detail, the foregoing description is in all aspects illustrative and not restrictive. It is understood that numerous other modifications and variations can be devised without departing from the scope of the invention.

The voice talk system of the present invention is particularly useful for a PTT-based voice talk apparatus which requires a technical effect such that the user is not likely to feel burden in a registration operation, a PTT-based voice talk apparatus which requires an effect such that the user of a sender's voice talk apparatus readily identifies a party on the other end of a talk, and the like.

What is claimed is:

1. A voice talk system in which a plurality of voice talk apparatuses and a voice talk control apparatus are connected to each other via a network so that the plurality of voice talk apparatuses and the voice talk control apparatus communicate with each other, wherein
the plurality of voice talk apparatuses include a sender's voice talk apparatus capable of transmitting a group talk and one or more receiver's voice talk apparatuses capable of receiving a group talk, and the voice talk control apparatus controls a group talk established between the sender's voice talk apparatus and the at least one of the receiver's voice talk apparatuses,
the sender's voice talk apparatus comprises:
a talk starting section operable to start a group talk;
a microphone operable to receive a voice input while the talk starting section is being operated;
an additional information obtaining section operable to obtain additional information required to group the receiver's voice talk apparatuses; and
a talk apparatus's transmission section operable to transmit the voice received through the microphone and the additional information obtained by the additional information obtaining section to the network, and
the voice talk control apparatus comprises:
a control apparatus's reception section operable to receive the voice and the additional information transmitted via the network from the sender's voice talk apparatus;
a search section operable to search a database configured to search the receiver's voice talk apparatuses, using at least one of the voice and the additional information received by the control apparatus's reception section, to specify at least one of the receiver's voice talk apparatuses with which the sender's voice talk apparatus can currently have a group talk; and
a grouping section operable to group the at least one of the receiver's voice talk apparatuses specified by the search section, and hold at least the receiver's voice talk apparatuses registered in the group until a group talk between the sender's voice talk apparatus and the receiver's voice talk apparatuses is ended.

2. The voice talk system according to claim 1, wherein, when the sender's voice talk apparatus has a push-to-talk function, the talk starting section is a button operable on the sender's voice talk apparatus.

3. The voice talk system according to claim 1, wherein, when the sender's voice talk apparatus can be carried in a vehicle, the additional information contains at least location information with which a current location of the sender's voice talk apparatus can be specified and identification information which is related to a user of the sender's voice talk apparatus, the location information contains at least one of the current location, a location of a destination, a movement speed, a traveling direction, and a route to the destination of the sender's voice talk apparatus, and the identification information contains at least one of a name, an age, an address, a telephone number, a mail address, a nickname, and preference information of a user of the sender's voice talk apparatus, and
the search section searches for the receiver's voice talk apparatus located in a vicinity of the current location, the destination, and/or the route to the destination of the sender's voice talk apparatus, with reference to the additional information.

4. The voice talk system according to claim 1, wherein the database contains status information indicating a current status of the receiver's voice talk apparatus, and
the search section searches for the receiver's voice talk apparatus with reference to status information contained in the database.

5. The voice talk system according to claim 4, wherein the status information indicates whether or not the receiver's voice talk apparatus is currently in use, and
the search section searches for the receiver's voice talk apparatus which is not currently in use, with reference to the status information contained in the database.

6. The voice talk system according to claim 1, wherein the voice talk control apparatus further comprises:
a voice accumulating section operable to buffer a voice received by the control apparatus's reception section;
a talk control section operable to establish a connection between the receiver's voice talk apparatuses grouped by the grouping section and the sender's voice talk apparatus; and
a control apparatus's transmission section operable to output the voice buffered in the voice accumulating section to the network to transmit the voice to the receiver's voice talk apparatuses grouped by the grouping section, when the connection is established by the talk control section.

7. The voice talk system according to claim 6, wherein the sender's voice talk apparatus further comprises:
a release requesting section operable to output a release request signal requesting release of a connection to any of the receiver's voice talk apparatuses having an established current connection with the sender's voice talk apparatus, in response to an operation of the sender's voice talk apparatus, and
the talk apparatus's transmission section further outputs the release request signal from the release requesting section to the network,
the control apparatus's reception section further receives the release request signal transmitted via the network from the sender's voice talk apparatus, and
the talk control section releases a connection with the receiver's voice talk apparatus designated by the release request signal received by the control apparatus's reception section.

8. The voice talk system according to claim 6, wherein the sender's voice talk apparatus further comprises a hold requesting section operable to output a hold request signal requesting holding of a connection to any of the receiver's voice talk apparatuses having an established current connection with the sender's voice talk apparatus, in response to an operation of the sender's voice talk apparatus,
the talk apparatus's transmission section further outputs the hold request signal from the hold requesting section to the network,
the control apparatus's reception section further receives the hold request signal transmitted via the network from the sender's voice talk apparatus, and
the talk control section releases a connection of the receiver's voice talk apparatuses other than the receiver's voice talk apparatus designated by the hold request signal received by the control apparatus's reception section.

9. The voice talk system according to claim 6, wherein the talk control section further establishes a new connection between the sender's voice talk apparatus, and the receiver's voice talk apparatuses which are grouped by the grouping section after disconnection of a first connection and to which the voice buffered in the voice accumulating section is not yet transmitted, and
the control apparatus's transmission section further transmits the voice buffered in the voice accumulating section to the receiver's voice talk apparatus having the new connection established by the talk control section.

10. The voice talk system according to claim 9, wherein the voice talk control apparatus further comprises a priority setting section operable to assign ordinal numbers as priorities for the talk control section to establish a connection, to the receiver's voice talk apparatuses grouped by the grouping section, and
the talk control section establishes a first connection with the receiver's voice talk apparatus having a highest priority assigned by the priority setting section.

11. The voice talk system according to claim 10, wherein the priority setting section assigns the priority with reference to location information and identification information contained in the additional information.

12. The voice talk system according to claim 10, wherein the voice talk control apparatus further comprises a voice recognizing section operable to analyze a voice received by the control apparatus's reception section to recognize contents uttered by a user of the sender's voice talk apparatus, and
the priority setting section assigns the priority with reference to a result of the recognition by the voice recognizing section.

13. The voice talk system according to claim 10, wherein the talk control section establishes a connection with the sender's voice talk apparatus in order of the priorities of the receiver's voice talk apparatuses assigned by the priority setting section, highest first.

14. The voice talk system according to claim 13, wherein the talk control section establishes a new connection when a non-voice interval continues for a predetermined time between voice talk apparatuses between which the previous connection is established.

15. A voice talk control apparatus of controlling a group talk established between a plurality of voice talk apparatuses connected via a network, comprising:
a control apparatus's reception section operable to receive a voice and additional information transmitted via the network from a sender's voice talk apparatus;
a search section operable to search a database configured to search receiver's voice talk apparatuses, using at least one of the voice and the additional information received by the control apparatus's reception section, to specify at least one of the receiver's voice talk apparatuses with which the sender's voice talk apparatus can currently have a group talk; and
a grouping section operable to group the at least one of the receiver's voice talk apparatuses specified by the search section, and hold at least the receiver's voice talk apparatuses registered in the group until a talk between the sender's voice talk apparatus and the receiver's voice talk apparatuses.

16. The voice talk control apparatus according to claim 15, wherein, when the sender's voice talk apparatus can be carried in a vehicle, the additional information contains at least location information with which a current location of the sender's voice talk apparatus can be specified and identification information which is related to a user of the sender's voice talk apparatus, the location information contains at least one of the current location, a location of a destination, a movement speed, a traveling direction, and a route to the destination of the sender's voice talk apparatus, and the identification information contains at least one of a name, an age, an address, a telephone number, a mail address, a nickname, and preference information of a user of the sender's voice talk apparatus, and
the search section searches for the receiver's voice talk apparatus located in a vicinity of the current location, the destination, and/or the route to the destination of the sender's voice talk apparatus, with reference to the additional information.

17. The voice talk control apparatus according to claim 15, wherein the database contains status information indicating a current status of the receiver's voice talk apparatus, and
the search section searches for the receiver's voice talk apparatus with reference to status information contained in the database.

18. The voice talk control apparatus according to claim 17, wherein the status information indicates whether or not the receiver's voice talk apparatus is currently in use, and
the search section searches for the receiver's voice talk apparatus which is not currently in use, with reference to the status information contained in the database.

19. The voice talk control apparatus according to claim 15, further comprising:
a voice accumulating section operable to buffer a voice received by the control apparatus's reception section;
a talk control section operable to establish a connection between the receiver's voice talk apparatuses grouped by the grouping section and the sender's voice talk apparatus; and
a control apparatus's transmission section operable to output the voice buffered in the voice accumulating section to the network to transmit the voice to the receiver's voice talk apparatuses grouped by the grouping section, when the connection is established by the talk control section.

20. The voice talk system according to claim 19, wherein the talk control section further establishes a new connection between the sender's voice talk apparatus, and the receiver's voice talk apparatuses which are grouped by the grouping section after disconnection of a first connection and to which the voice buffered in the voice accumulating section is not yet transmitted, and
the control apparatus's transmission section further transmits the voice buffered in the voice accumulating section to the receiver's voice talk apparatus having the new connection established by the talk control section.

21. The voice talk control apparatus according to claim 20, wherein the voice talk control apparatus further comprises a priority setting section operable to assign ordinal numbers as priorities for the talk control section to establish a connection, to the receiver's voice talk apparatuses grouped by the grouping section, and
the talk control section establishes a first connection with the receiver's voice talk apparatus having a highest priority assigned by the priority setting section.

22. The voice talk control apparatus according to claim 21, wherein the priority setting section assigns the priority with reference to location information and identification information contained in the additional information.

23. The voice talk control apparatus according to claim 21, further comprising a voice recognizing section operable to analyze a voice received by the control apparatus's reception section to recognize contents uttered by a user of the sender's voice talk apparatus, and
the priority setting section assigns the priority with reference to a result of the recognition by the voice recognizing section.

24. The voice talk control apparatus according to claim 21, wherein the talk control section establishes a connection with the sender's voice talk apparatus in order of the priorities of the receiver's voice talk apparatuses assigned by the priority setting section, highest first.

25. The voice talk control apparatus according to claim 24, wherein the talk control section establishes a new connection when a non-voice interval continues for a predetermined time between voice talk apparatuses between which the previous connection is established.

26. A voice talk control method of controlling a group talk established between a plurality of voice talk apparatuses connected via a network, comprising:
a talk starting step performed by a sender's voice talk apparatus in response to an operation for starting a group talk;
a voice input step of receiving a voice input while the talk starting step is being operated, the voice input step being performed by the sender's voice talk apparatus;
an additional information obtaining step of obtaining additional information required to group receiver's voice talk apparatuses, the additional information obtaining step being performed by the sender's voice talk apparatus;
a transmission step of transmitting the voice received in the voice input step and the additional information obtained in the additional information obtaining step to the network, the transmission step being performed by the sender's voice talk apparatus;
a reception step of receiving a voice and additional information transmitted via the network from the sender's voice talk apparatus, the reception step being performed by the voice talk control apparatus;
a search step of searching a database configured to search the receiver's voice talk apparatuses, using at least one of the voice and the additional information received by the reception step, to specify at least one of the receiver's voice talk apparatuses with which the sender's voice talk apparatus can currently have a group talk, the search step being performed by the voice talk control apparatus; and
a grouping step of grouping the at least one of the receiver's voice talk apparatuses specified by the search step, and holding at least the receiver's voice talk apparatuses registered in the group until a group talk between the sender's voice talk apparatus and the receiver's voice talk apparatuses is ended, the grouping step being performed by the voice talk control apparatus.

27. Avoice talk control program of controlling a group talk established between a plurality of voice talk apparatuses connected via a network, wherein
a sender's voice talk apparatus comprises:
a talk starting section operable to start a group talk;
a microphone operable to receive a voice input while the talk starting section is being operated;
an additional information obtaining section operable to obtain additional information required to group receiver's voice talk apparatuses; and
a talk apparatus's transmission section operable to transmit the voice received through the microphone and the additional information obtained by the additional information obtaining section to the network, and
the voice talk control program comprises:
a reception step of receiving the voice and the additional information transmitted via the network from the sender's voice talk apparatus, the reception step being performed by the voice talk control apparatus;
a search step of searching a database configured to search the receiver's voice talk apparatuses, using at least one of the voice and the additional information received by the reception step, to specify at least one of the receiver's voice talk apparatuses with which the sender's voice talk apparatus can currently have a group talk, the search step being performed by the voice talk control apparatus; and
a grouping step of grouping the at least one of the receiver's voice talk apparatuses specified by the search step, and holding at least the receiver's voice talk apparatuses registered in the group until a group talk between the sender's voice talk apparatus and the receiver's voice talk apparatuses is ended, the grouping step being performed by the voice talk control apparatus.
